(19) United States
(12) Patent Application Publication
(10) Pub. No.: US 2012/0030069 A1
(43) Pub. Date: Feb. 2, 2012

(54) PRODUCT QUOTATION PREPARATION SYSTEM AND METHOD

(75) Inventors: Amit Garg, Shaker Heights, OH (US); Kaushik Basu, Milpitas, CA (US); Kunal Jaura, San Francisco, CA (US)

(73) Assignee: CRMANTRA, INC., Emeryville, CA (US)

(21) Appl. No.: 13/257,058

(22) PCT Filed: Mar. 16, 2010
(86) PCT No.: PCT/US10/27390

§ 371 Date: Sep. 16, 2011

Related U.S. Application Data
(60) Provisional application No. 61/210,224, filed on Mar. 16, 2009.

(51) Int. Cl. G06Q 30/00

(52) U.S. Cl. 705/27.1; 705/26.1

(57) ABSTRACT

A method and an apparatus (system) for support in performing the method is provided to configure products and/or services in support of preparing quotations, orders, and fulfillment requests in support of a Customer Relationship Management (CRM) system and method. More specifically, a method and an apparatus (system) is provided for supporting the quotation, ordering, and fulfillment of products and services by aiding in the configuration of products and/or services in an automated and efficient fashion.

### CROSS-REFERENCES TO RELATED APPLICATIONS

This application claims the benefit of provisional patent application Ser. No. 61/210,224, filed on Mar. 16, 2009, incorporated herein by reference.

### BACKGROUND OF THE INVENTION

This application relates generally to a method and apparatus (system) to configure products and/or services in support of preparing quotations, orders, and fulfillment requests in support of a Customer Relationship Management (CRM) system and method.

More specifically, this application relates to a method and apparatus (system) for supporting the quotation, ordering, and fulfillment of products and services by aiding in the configuration of products and/or services in an automated and efficient fashion.

Selling configurations of products and/or services is a common practice that spans many different industries. For manufacturers, examples of product configurations would include automobiles with their concomitant options, computer systems, machine tools, networking gear, etc. For telecommunications service providers, some examples of product configurations would include wireless service plans, data and internet access plans. A financial services and insurance industry example could be an insurance plan with different types of coverage options. In the case of the oil industry, a product configuration may include a set of oil well drilling and seismic analysis services which also include hardware such as drill bits, cables, pumps, and other equipment, for example.

As one can see from the examples presented above, among many others, the practice of selling configurations of products and/or services is very widespread. Most of the time while selling configurations of products, there are rules among many options comprising the desired configuration. These rules are driven by, for example, technical, marketing, commercial, and/or regulatory requirements. Examples of these rules include: options that need to be purchased together, options that cannot be purchased together, minimum/maximum quantities for a given option, etc. From a business user's perspective, these rules can be defined across options, across groups of options (such as product categories or product families, or any arbitrary grouping), across options or groups of options based on what the customer has previously purchased, and/or across options or groups of options based on who the customer is, and/or where they are located, and/or where the products/services will be delivered or consumed, for example.

Most businesses would like the “ownership” or the knowledge of product configurations and their rules to reside within their product marketing/product management organizations because they drive the marketing, sales, and manufacturing requirements for products. However, configuration definitions and rules (what are called herein “Business Rules”) are implemented very differently in most applications (what are called herein “Application Rules”). As a result, business users tend to rely on programmers and IT staff to implement their “Business Rules” into a software application. Often times the implementation of these “Business Rules” would result in over 100-fold increase in the number of “Application Rules” entered into the software application. To make matters even worse, the “Application Rules” representing “Business Rules” are distributed as data entered through the user interface, and/or workflow processes, and/or scripts or programming macros embedded in the application. This Business Rule-Application Rule gap is the main driver of the high cost and complexity of implementation of product configurations and quoting systems. This gap also drives poor run-time performance, poor application usability, product configuration maintenance complexity, and the time required to introduce new product and service offerings. Useful would be a better method and apparatus for providing product configurations provide one or more of: faster run-time performance, better usability, and/or higher maintainability, thereby resulting in faster time to market for new products and services and also resulting in less error-prone product quotations by reducing the number of rules, and/or the complexity of the rules, to increase efficiency.

### SUMMARY OF THE INVENTION

Provided are a plurality of embodiments in the examples of the invention, described in more detail below, that solve one or more of the problems of the prior art in support of product configuration for accurate quotations to support a CRM process. In particular, the System provides a computerized tool for developing a quotation, such that the tool aids the user in evaluating various permitted product configurations that can traverse any number of hierarchies such as pre-defined sales region hierarchy and product-level hierarchies, for example. These and other hierarchies enable the user to define rules at the most efficient level of the hierarchy resulting in fewest possible rules to be evaluated by the configuration engine. In addition, the rule definition paradigm also utilizes a rule-and-exception concept to further reduce the number and complexity of the product configuration rules to be defined in software executing on a computer. The system could utilize distributed computing such that the user may access a server that is remote from the user over a network such as the Internet.

Provided is a method for determining a product model permitted by a vendor, with the method comprising the steps of:
receiving information including:
   Information about at least one requested product configuration and/or at least one requested product application; and
   Information for determining an availability of the product in its requested configuration(s) and/or for the requested application(s) for a requested sales structure;
providing a plurality of business rules in the computer system, wherein
   at least one of the business rules is comprised of a general rule and at least one exception, and wherein
   at least two of the business rules are hierarchically arranged with respect to each other such that one of the hierarchically arranged rules takes precedence over the other(s) of the hierarchically arranged rules;
applying the plurality of business rules to the information to provide information indicating an assessment of:
   (1) whether the requested product configuration is or is not a permitted product configuration and/or whether the product is or is not permitted for the requested product application, and
   (2) whether the desired sales structure is or is not a permitted sales structure.

Also provided is a method of using a computer system for determining a product model permitted by a vendor, with the method comprising the steps of:
receiving information into the computer system from a remote terminal connected to the computer system via a communication network, the information including:
   Information about at least one requested product configuration and/or at least one requested product application; and
   Information for determining an availability of the product in its requested configuration(s) and/or for the requested application(s) for a requested sales structure;
storing a plurality of business rules in the computer system, wherein
   at least one of the business rules is comprised of a general rule and at least one exception, and wherein
   at least two of the business rules are hierarchically arranged with respect to each other such that one of the hierarchically arranged rules takes precedence over the other(s) of the hierarchically arranged rules;
applying, using the computer system, the plurality of business rules to the information to generate at least one product report as a result of the applying the plurality of business rules, such that the product report provides information indicating an assessment of:
   (1) whether the requested product configuration is or is not a permitted product configuration and/or whether the product is or is not permitted for the requested product application, and
   (2) whether the desired sales structure is or is not a permitted sales structure; and
providing, using the computer system, the product report to the remote terminal via the computer network.

Further provided is a method for determining a product model permitted by a vendor, with method comprising the steps of:
providing a plurality of business rules, wherein the business rules include the syntax of:
   a subject,
   an object, and
   a verb, wherein
   the business rules include a subset of compatibility rules such that, for each one of the compatibility rules, the respective subject represents a particular aspect of the product, the respective object represents some other aspect of the product, its options, another product, or a product application, and the respective verb represents some action between them, and wherein
   the business rules also include a subset of availability rules such that, for each one of the availability rules, the respective subject represents the product, the respective object represents a selling domain, and the respective verb represents some action between them, and wherein
   at least some of the business rules are hierarchically arranged with respect to each other such that the hierarchically arranged rules takes precedence over each other based on their position in the hierarchy;
receiving information, the information including:
   Information about at least one requested product configuration and/or at least one requested product application, and
   Information for determining an availability of the product in its requested configuration(s) and/or for the requested application(s) for a requested sales structure;
applying the compatibility rules to the information to determine whether the requested product configuration is or is not a permitted product configuration and/or whether the product is or is not permitted for the requested product application, and
applying the availability rules to the information to determine whether the desired sales structure is or is not a permitted sales structure.

Further provided is a method of using a computer system for determining a product model permitted by a vendor, with method comprising the steps of:
Inputting a plurality of business rules for storing in the system, wherein the business rules include the syntax of:
   a subject,
   an object, and
   a verb, wherein
   the business rules include a subset of compatibility rules such that, for each one of the compatibility rules, the respective subject represents a particular aspect of the product, the respective object represents some other aspect of the product, its options, another product, or a product application, and the respective verb represents some action between them, and wherein
   the business rules also include a subset of availability rules such that, for each one of the availability rules, the respective subject represents the product, the respective object represents a selling domain, and the respective verb represents some action between them, and wherein
   at least some of the business rules are hierarchically arranged with respect to each other such that the hierarchically arranged rules takes precedence over each other based on their position in the hierarchy;
receiving information into the computer system from a remote terminal connected to the computer system via a communication network, the information including:
   Information about at least one requested product configuration and/or at least one requested product application, and
   Information for determining an availability of the product in its requested configuration(s) and/or for the requested application(s) for a requested sales structure;
applying, using the computer system, the compatibility rules to the information to determine whether the requested product configuration is or is not a permitted product configuration and/or whether the product is or is not permitted for the requested product application, and
applying, using the computer system, the availability rules to the information to determine whether the desired sales structure is or is not a permitted sales structure; and
providing, using the computer system, a product report to the remote terminal via the computer network to report results from the applying steps.

Further provided are any of the above methods comprising additional features that may be optional based on the needs of the user.

Also provided are one or more systems for implementing any of the above methods.

Still further provided is a system for determining a product model permitted by a vendor, with the system comprising: a web server for serving data to, and receiving information from, a user computer, wherein the received information includes: information about at least one requested product configuration and/or at least one requested product application, and Information for determining an availability of the product in its requested configuration(s) and/or for the requested application(s) for a requested sales structure.

The above system also comprises an application server for executing included software for implementing business logic for producing data that is formatted into a report by the web server for transmission to the remote computer, wherein the business logic includes a plurality of business rules such that: at least one of the business rules is comprised of a general rule and at least one exception, and such that at least two of the business rules are hierarchically arranged with respect to each other such that one of the hierarchically arranged rules takes precedence over the other(s) of the hierarchically arranged rules.

The business logic of the above system applies the plurality of business rules to the received information to generate at least one product report as a result of applying the plurality of business rules, such that the product report provides information indicating an assessment of: (1) whether the requested product configuration is or is not a permitted product configuration and/or whether the product is or is not permitted for the requested product application, and (2) whether the desired sales structure is or is not a permitted sales structure.

The above system also comprises providing, using the web server, the product report to the user computer.

### BRIEF DESCRIPTION OF THE DRAWINGS

The features and advantages of the examples of the example embodiments described herein will become apparent to those skilled in the art to which the present examples relate upon reading the following description, with reference to the accompanying drawings, in which:

FIG. 1 shows a simplified context diagram representing a top-level view of an example embodiment;

FIGS. 1A and 1B depict a high-level example of software and hardware network infrastructure of the example embodiment

FIG. 2 provides a block diagram describing the example embodiment of the System showing a Rules Engine Module;

FIG. 3 depicts a summary of a generic hierarchy and precedence among rules defined at different levels of a hierarchy;

FIG. 4A depicts an example selling domain hierarchy of the example embodiment;

FIG. 4B depicts an example of a product-based hierarchy of the example embodiment;

FIG. 5 depicts a schematic of a user interface to define the rules in the example embodiment;.

FIG. 6 depicts reducing the gap between business rules and application level rules in Availability definitions in the example embodiment;

FIGS. 7A, 7B, and 7C are flow charts for describing a methodology to enforce the Availability rules for the example embodiment;

FIG. 8 describes different types of Compatibility Rules. that can be defined at any level of the product hierarchy in the example embodiment;

FIGS. 9A and 9B depict a schematic of the user interface used to define Compatibility rules and their exceptions in the example embodiment; and

FIGS. 10A, 10B, 10C, 10D, 10E, and 1OF describe logic provided in the Compatibility Rule enforcement in the example embodiment.

### DETAILED DESCRIPTION OF THE EXAMPLE EMBODIMENTS

In order to devise a better method and apparatus to address the Business Rules-Application Rules gap, one needs to identify the main characteristics of Business Rules as they are used herein. Business rules are provided in a sentence, often expressed in general terms with exceptions, and contain implicit concepts of hierarchy and precedence. An example of a Business Rule is “All portable computers have an internal CD/DVD Drive, except Net Books which do not have an internal CD/DVD Drive”. This rule contains a general rule and an exception. In addition, it has an implicit reference to a hierarchy among products, i.e., the grouping of “portable computers” comprises of the sub-group called “Net Books”. Another example of a Business Rule is “The Platinum Service Coverage is available for all automobiles except Four-Wheel Drive automobiles, and can be sold to customers in North America except in Mexico and the states of Texas and Florida.” This Business Rule refers to multiple exceptions, one for the type of products and other to the locations. In each case, there is an implicit reference to hierarchies. The rule implies that the group of Four-Wheel Drive cars belongs to the group of automobiles, and Mexico, Texas, and Florida are part of North America. The inability of most software applications to readily handle the three Business Rules' characteristics leads to the Business Rules-Application Rules gap. The example embodiment describes how the Business Rules-Application Rules gap is closed to address the challenges (as described above) in defining and managing quotes and configurations of products.

In the Business Rule examples cited above, most software applications would be unable to handle exceptions. As a result, the “general rule” described above and its exceptions have to be explicitly defined as “Application Rules” within the software application. In addition, existing software applications also do not support definition of hierarchies and the enforcement of precedence rules that underlie these hierarchies. For example, in the selling domain hierarchy, a state-level rule would take precedence over a country level rule, and in a product hierarchy, a product-level rule is more specific than product family level rules. These are the reasons behind the over 100-fold proliferation of rules that occurs when Business Rules are implemented as Application Rules within a software application.

The system and method(s) described in detail, below, can be configured to operate with a System that provides quoting and product configuration support, such as Oracle's Siebel CRM application or other CRM or ERP system (such as SAP, or Oracle's E-Business Suite, for example), or a custom application, and supports a 3-tier client-server architecture comprising User Interface, Database, and servers, for example. This application can utilize a CRM and/or Quoting application such as Oracle's Siebel version 7.8 and higher software. This software can be installed on a Window's or a Unix based machine, for example. The Windows based machine would preferably have Windows NT or higher versions of the operating system. All flavors of Unix, such as Solaris, AIX, and HP-UX can be supported as operating systems on the computer hardware. Since this application operates within a 3-tier client server architecture, it preferably utilizes a web browser for its user interface. The application supports multiple web browsers such as Internet Explorer version 6 or higher and Mozilla Firefox, and could also support other web browser applications, if desired. The database systems used for a preferred system include Oracle, Microsoft SQL Server, IBM's DB2, and Sybase's SQL Anywhere.

The described system and method(s) can also be delivered in a Software-as-a-service mode (also known as “SaaS”, supporting “cloud computing”) wherein the above-mentioned 3-tier client server architecture does not require installation of any software in the end-user customer's premises, but instead utilizes standard applications typically installed on a user device such as a user workstation running a commercially available operating system, such as Windows, Linux, etc. and utilizing standard web-interface software, such as the web browsers discussed above. In this case, the database and the underlying application can be hosted in a remote site utilizing standard commercially available server hardware, while the customer only needs to have access to an internet connection to the user device.

Users/customers of the System could be charged in many different ways, described in the examples provided below. The payment could be based on purchasing software licenses charged up front on the basis of one or more of the criteria, such as: the number of named users, concurrent users, number of CPU processors in the hardware on which it is deployed; and/or as recurring payment based on the number of quote or order line items that are processed by the application; and/or as a recurring payment based on a pre-determined percentage of the revenue of the quotes and orders that are processed by the application; and/or as periodic (monthly, quarterly, annual, weekly, etc.) subscription based on number of users accessing the application, etc.

Basically, the System allows a user to determine whether a desired product model is permitted or not. Vendors often put restrictions on what product configurations (e.g., product with options), or which product applications (compatibility of products, selling products together, etc.) can be marketed, and vendors also limit the permissible sales structure, such as by indicating, for example, in which geographical locations (cities, states, countries, continents, etc.), different product configurations are allowed, and which geographical locations certain configurations are not allowed, and even with the product being completely prohibited in some geographical locations (e.g., perhaps for legal reasons, or competitive reasons). Thus, a user can use the System to obtain information about permitted and prohibited marketing structures, allowing the user to determine an acceptable sales structure for marketing (or, in the case of an end user, for consuming) a product (which could be a service) as provided by the vendor (such as a wholesaler, retailer, manufacturer, etc.).

For example, automobiles often have optional accessories and add-ons that are provided in certain geographical locations, but not other locations. Some regions may be provided with winter packages, for example (such as Canada and the Northern United States, where all-wheel-drive and mirror defrosters might be popular), whereas different packages might be offered in warm-weather climates (such as South America, Mexico, and the Southern United States, where convertibles and sun-roofs might be more popular). Furthermore, some accessories cannot be installed with other accessories. For example, a sun-roof is never provided on a convertible automobile. The System utilized the logical rules discussed below in order to provide a means to easily determine “what” configurations are permissible “where”, and when not permitted.

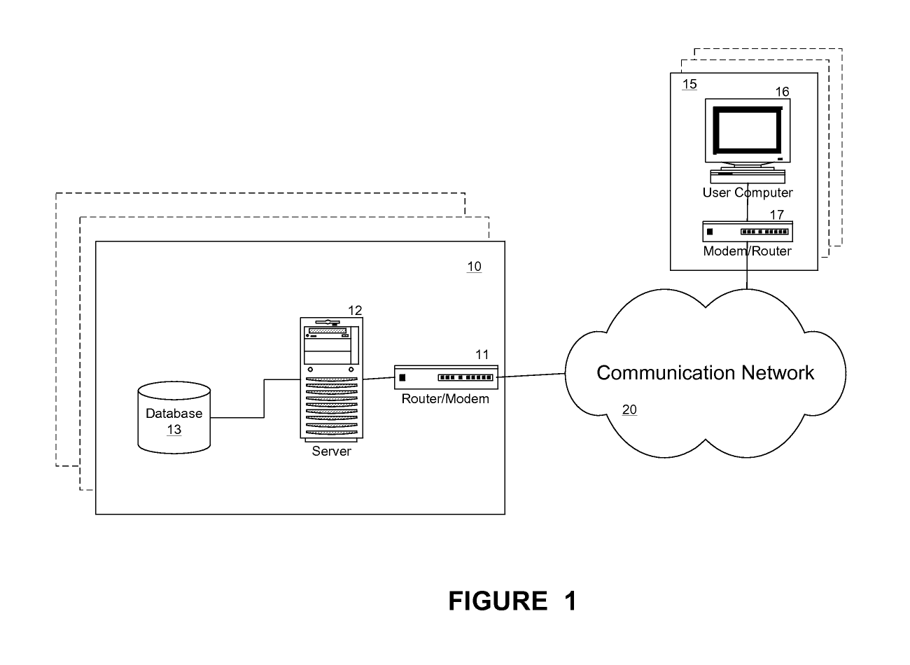

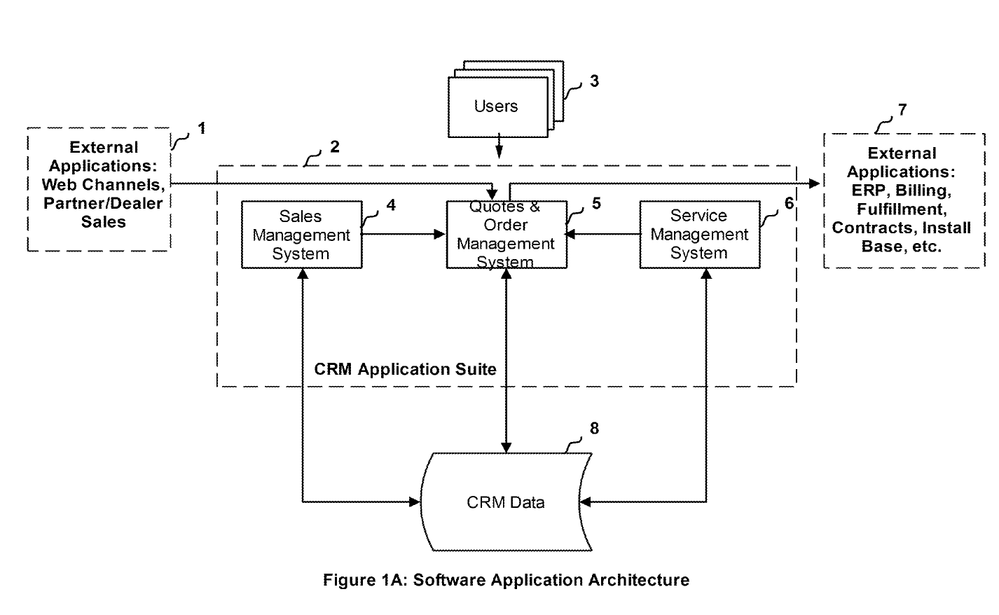

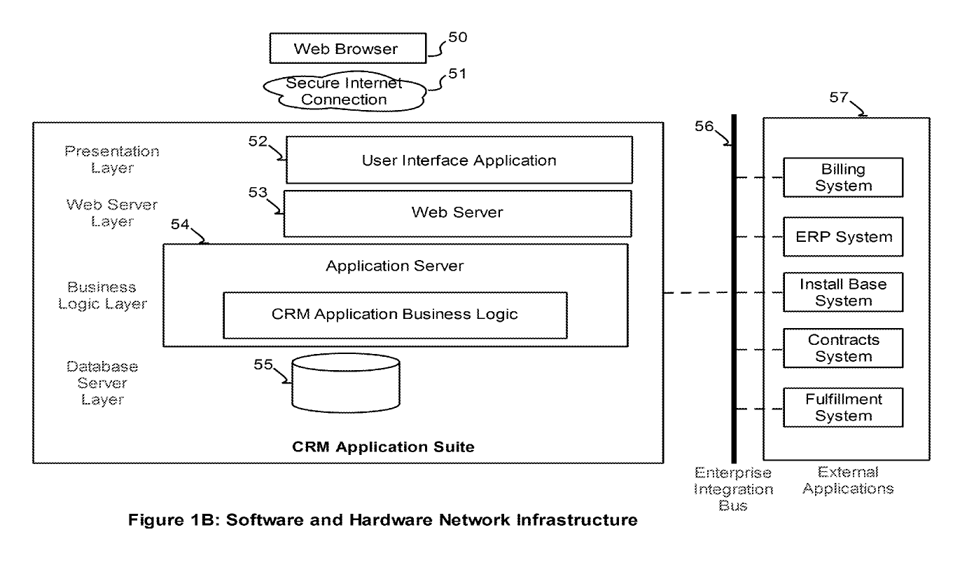

FIG. 1 shows a simplified context diagram of such a System, where the server(s) 10 hosting the System described herein can utilize a computer 12, such as might be running an operating system such as Windows Server running Windows Internet Information Server (IIS), connected to an internal or external storage device 13 and a modem/router 11 for connecting to an external communication network 20 (or to an internal network that is connected to the external network). The choice of such a network would most likely be the Internet (or a network connected to the Internet), but any communication network that can connect two computers could be utilized. There could be plurality of such devices, such as a server farm, for example. A plurality of user devices 15 are connected to the external network 20, with each user device including a user computer 16 connected to a modem/router 17 for connecting to the external network 20. Of course, many different configurations can also be supported, as many different users each may have their own internal system design, and the System can be configured to utilize a number of different host architectures. Thus, the system design of FIG. 1 is merely an example of a typical arrangement that might be utilized. The computers of the system might utilize only a single processor, or preferably could utilize multiple processors, as is ubiquitous in modern computer hardware.

FIGS. 1A and 1B describe, in more detail, an example architecture of one embodiment of a System in which such a solution could be deployed (alternative embodiments can also be provided utilizing different architectures having similar functionality, such as by distributing components across remote locations, for example). Requests for quotes and configuration of products can come from Users 3 interacting with the CRM Application Suite 2 or from External Applications such as Web Portals, Partner/Dealer Sales channel 1. Within the CRM Application Suite 2, Users 3 may be sales or marketing users, product administrators, pricing administrators, and managers, or requests being placed by a remote application or device that is integrated with the CRM Application Suite 2. These users typically would work with the Sales Management System 4 or the Quotes & Order Management System 5 within the CRM Application 2. During this process they may create leads and opportunities (in the Sales Management System 4) that eventually turn into quotes (in the Quotes & Order Management System 5) that need to be configured and validated before being presented to the end customer. Products, quantities, and prices specified by the user are also synchronized back to the opportunities (in the Sales Management System 4) in order to improve the quality of data required to forecast sales pipeline and future product shipments. Interactions with the CRM Application modules require data to fetched or written or updated in the CRM Data store 8.

On the other hand, if the users are service representatives, they may be interacting with the Service Management System 6 or directly with the Quote and Order Management System 5 within the CRM Application Suite 2. Within the Service Management System 6, the service representative may create a service request, followed by creation of a quote or an order (in the Quotes & Order Management System 5) for spare parts, services, and additional purchases an existing customer may buy. Again, these interactions would require fetching data, and/or writing, and/or updating data in the CRM Data store 8. Once the quote is created and product configurations are completed, it has to be accepted by the customer. A quote that has been accepted by the customer is now ready to be sent to the External Applications 7 such as ERP, Billing, Fulfillment systems, for example. Some of the line items from the quote will convert into Install Base items, and/or Contract terms and conditions.

FIG. 1B depicts an example software and hardware network infrastructure. The application infrastructure is comprised of several layers. The database server layer 55 stores all the data. This server may comprise several databases, each storing different types of data. The Application Server 54 in the Business Logic layer has all the business logic encapsulated in the CRM Application Suite described in FIG. 1A. The Application Server 54 gets all its data from the data repository available in the Database Server Layer 54. End users access the application through a Web Browser 50 that connects to the CRM Application through a secure internet connection 51. The user can interact with the CRM Application Suite modules through the User Interface Application 52 which interacts with the Web Server 53 used to serve up the web content from the Application Server 54. As a result of user interactions with the CRM Application Suite, some external data will likely need to be accessed or some data will likely need to be updated in external systems. Interactions between systems are conducted through the Enterprise Integration Bus 56. The Enterprise Integration Bus 56 is the centralized messaging infrastructure through which messages are exchanged among various systems such as the CRM Application Suite and among the applications in the External Applications 57.

Applications described in FIGS. 1, 1A, and 1B can be written using standard programming languages such as Java, C++, etc., or proprietary programming languages such as SAP's ABAP, Siebel Script, etc. Integrations between different applications are done using industry-best practices such as web services, or custom point-to-point integrations that map XML messages between different applications. As part of integrations between systems, systems exchange data in the form of messages in an XML or a similar format. These messages can be conveyed using any of the multiple commercially available integration platforms such as TIBCO, Webmethods, MQ Series, BizTalk, etc, or a custom integration platform technology.

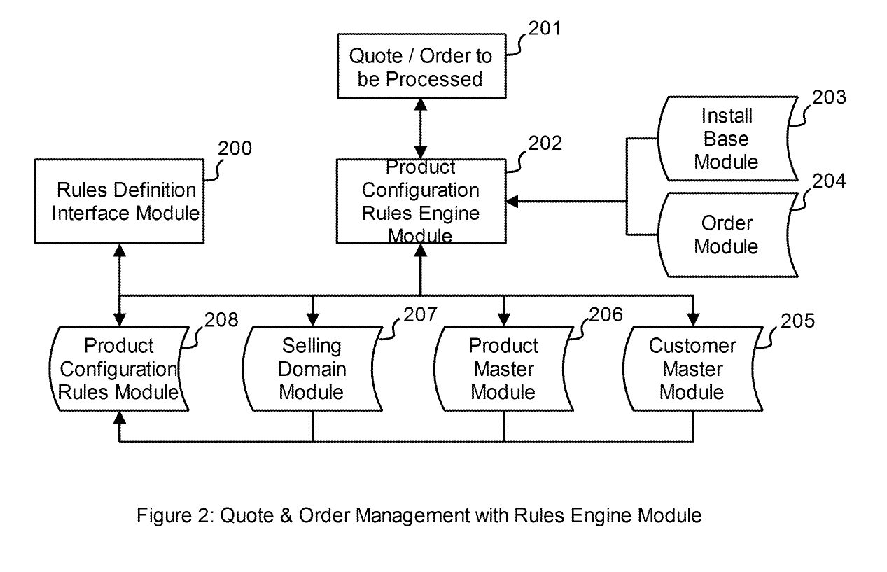

FIG. 2 describes a block diagram of an example of how the Quoting and Order Management System can be implemented in a computer system of the example embodiment, in conjunction with the product configuration rules definition and enforcement (through an engine). This figure describes two types of usages of the system, administrative to define/input the rules and run-time to enforce the rules defined by the administrator.

The Rules Definition Interface 200 in FIG. 2 is the interface through which rules are defined/input into the Product Configuration Rules Module 208 data store. The Rules Definition Interface Module 200 could be a graphical user interface on a computer system or could be a means to upload data through some web services into the Product Configuration Rules Module 208 data store. Each entity in referred to in the Rules data that is entered in the Product Configuration Rules Module 208 data store should be validated against their original data store such as customer data through the Customer Master Module 205 data store, all product-related data including product hierarchy definitions, product family definitions, and product-product option relationship definitions against the Product Master Module 206 data store, and all selling domain-related data such as geographical locations, channel types, etc, against the Selling Domain Module 207 data store.

At run time, rule enforcement part of the FIG. 2 block diagram comprises the input to the Product Configuration Rules Engine Module 202 from Quote/Order to be Processed 201. Quote/Order to be Processed 201 comprises an object (such as a quote or an order) containing product configurations that need to be validated against rules defined by the administrator in the Product Configuration Rules Module 208 data store. This object also can contain, for example, information such as customer name, customer location, selling domain-related data such as customer location where the product will be sold, sales channel, etc. The Product Configuration Rules Engine Module 202 will validate the basic entity data such as product data in the quote/order with the data stored in the Product Master Module 206 data store, customer-related data with the data stored in the Customer Master Module 205 data store, and selling domain-related data with the data stored in the Selling Domain Module 207 data store. Once these validations are cleared, the Product Configuration Rules Engine Module 202 loads all the relevant product configuration rules from the Product Configuration Rules Module 208 data store, all relevant install base (or assets) from the Install Base Module 203 data store, all relevant previous orders from that customer that are not yet fulfilled from the Order Module 204 data store, selling domain hierarchy information from the Selling Domain Module 207 data store, and the product hierarchy from the Product Master Module 206 data store.

Again referring to FIG. 2, the Product Configuration Rules Engine Module 202 processes all the relevant rules, related information such as the customer information, customer's install base (or asset) information, customer's open orders, product hierarchy, and selling domain hierarchy to determine if the requested product configuration(s) in the input quote/order document are valid or not. It is to be noted that the scope of rules enforced by the Product Configuration Rules Engine Module 202 spans the selection of options within the quote/order, status of install base with that customer, and the product configurations the customer may have in orders that are not yet fulfilled. If the requested product configuration is not valid, the rules engine flags options that are not valid with a message indicating the rule(s) that have been violated. This tagged quote/order is output to Quote/Order to be Processed 201.

In the example embodiment, there are two types of product configuration rules in the Product Configuration Rules Module 208 data store depicted in FIG. 2. These include the Availability Rules (or alternatively, called “eligibility rules”) that pertain to, for example, the “where” of product configuration rules (e.g., geographical locations where certain products or particular product configurations are permitted, and/or not permitted), and Compatibility Rules pertaining to, for example, the “what” of product configuration rules (e.g., permitted product configurations, prohibited product configurations, permitted applications, and/or prohibited applications).

An example of an Availability Rule is “Product A is not available for sales in the reseller channel in South Korea”. Examples of criteria that can be used in Availability Rules definitions could include geographical locations, channels, customer types, and/or customer names, action code such as new customer or a renewal customer, and/or a MACD (Move, Add, Change, or Delete) action codes. These criteria can also be used in combinations with one another to address more sophisticated Availability Rules definitions.

Compatibility Rules definitions enable the user to define what options need to be sold together, and which options cannot be sold with one another, for example. Thus, the user can request various product configurations and/or various product applications, and also request whether such configurations/applications are available in certain marketing channels, geographical locations, etc. Examples of criteria that can be used in Compatibility Rules definitions include product options, Product Categories, Product Family, any arbitrary grouping of options, option quantity, etc. The definition and enforcement of these types of rules is detailed later in this application.

Availability Rules is an area where the gap between Business Rules and Application Rules is often quite large. This gap can result in rules proliferation, poor usability, and performance and scalability issues because the Product Configuration Rules Engine Module 202 has to load and evaluate a very large number of rules. As a result of the problems stemming from the Business Rule-Application Rule gap, the time to market for new products and services becomes quite large.

The Business Rule-Application Rule gap for Availability Rules stems from the complexity of translating a rule expressed in natural language into constructs in the software application, and non-existence of unified hierarchy definition and hierarchy-based rule enforcement for various entities. Key features of the example System described below are provided to overcome one or more of these problems.

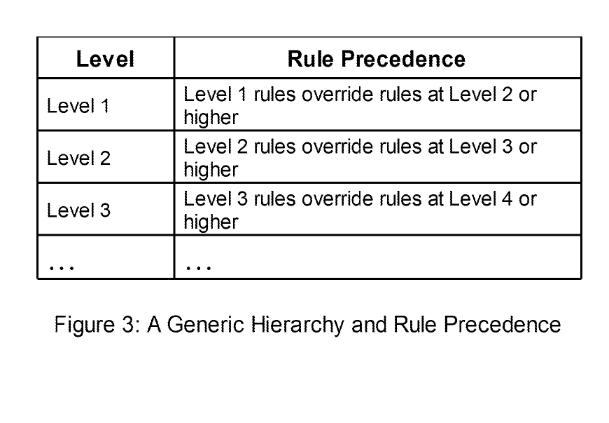

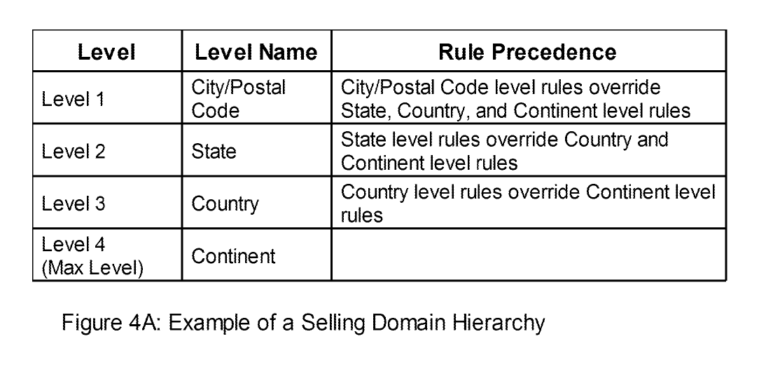

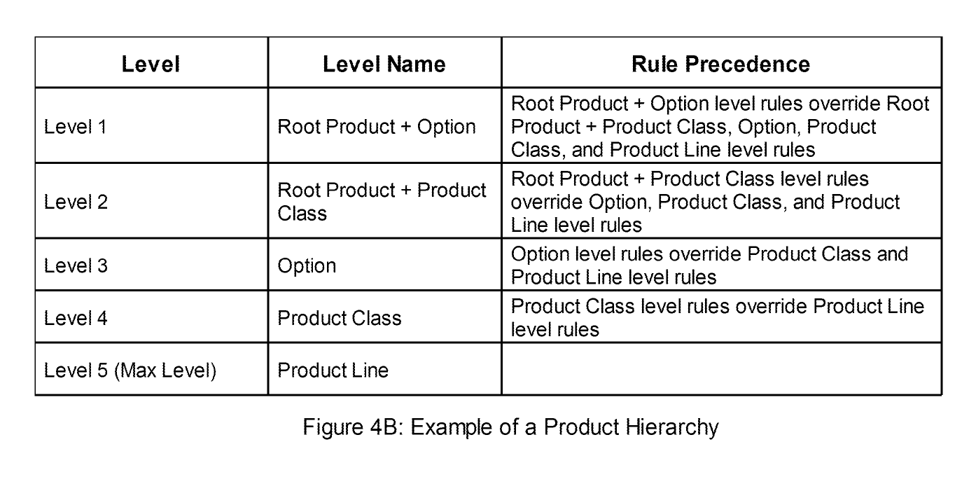

The System features a flexible hierarchy definition capability. The user can define as many levels as desired in a hierarchy. FIG. 3 depicts a summary of a generic hierarchy and precedence among rules defined at different levels of the hierarchy. Rule precedence is enforced by the rules engine. Rules at the most granular level of the hierarchy, such as Level 1, override rules that are at a less granular level. For example, in a selling domain hierarchy as depicted in the example of FIG. 4A, City/Postal Code level rules will override rules defined at State, Country, and Continent levels. City/Postal Code is more “granular” than a State, Country, or a Continent. Similarly, FIG. 4B depicts an example of a product-based hierarchy. The method provided by the example System enables the user to define hierarchies on any object. Another example of a hierarchical object could be customer. An example of defining a customer hierarchy would be to have Customer as Level 1, Parent Customer as Level 2, Parent Customer SIC Code as Level 3, etc. Yet another example of a hierarchy could be based on channel.

The hierarchy capability in the example System is very flexible in addressing the requirement of traversing a hierarchy comprising multiple objects. In this case, the Levels described in a generic hierarchy can be assigned to combinations of values from each hierarchical object. For example, one may want to define a hierarchy comprising of selling domain and channel. In this example, let us assume that a Selling Domain object has two levels, Country and Continent. Let us also assume that a Channel has two levels, channel type (with values such as Direct and Partner) and channel medium (Field Sales and Web), the lowest level of this hierarchy in the example will have values such as Direct-Field Sales, Direct Web, Partner Field Sales, and Partner Web). A hierarchy representing the combination of these would explicitly assign each combination of values from the two objects to a level in the generic hierarchy described in FIG. 3.

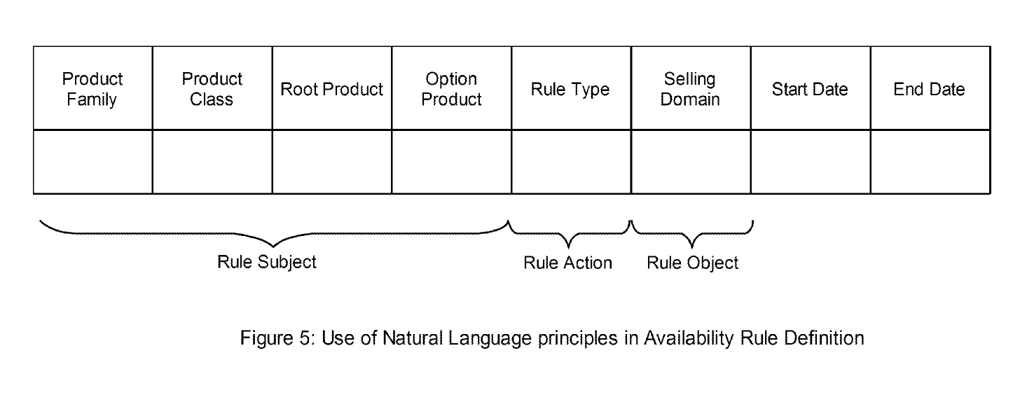

In order to simplify rules administration and maintainability, the rules definition should follow the natural language principles used in expressing them. FIG. 5 depicts the schematic of a user interface to define the rules. In natural language, each sentence comprises a subject, a verb, and an object. Similarly, the availability rules defined within the example System can be parsed into a rule subject comprising a combination of values, such as Product Family, Product Class, Root Product, and Option Product; rule action (or verb) that can take values of, for example, Available or Not Available; and a rule object that refers to a value from the selling domain. One can see that the rule subject refers to the product hierarchy described earlier and the rule object refers to the selling domain hierarchy values. These are illustrative examples and one could, for instance, replace the reference to selling domain hierarchy values with values from any other hierarchy as described above.

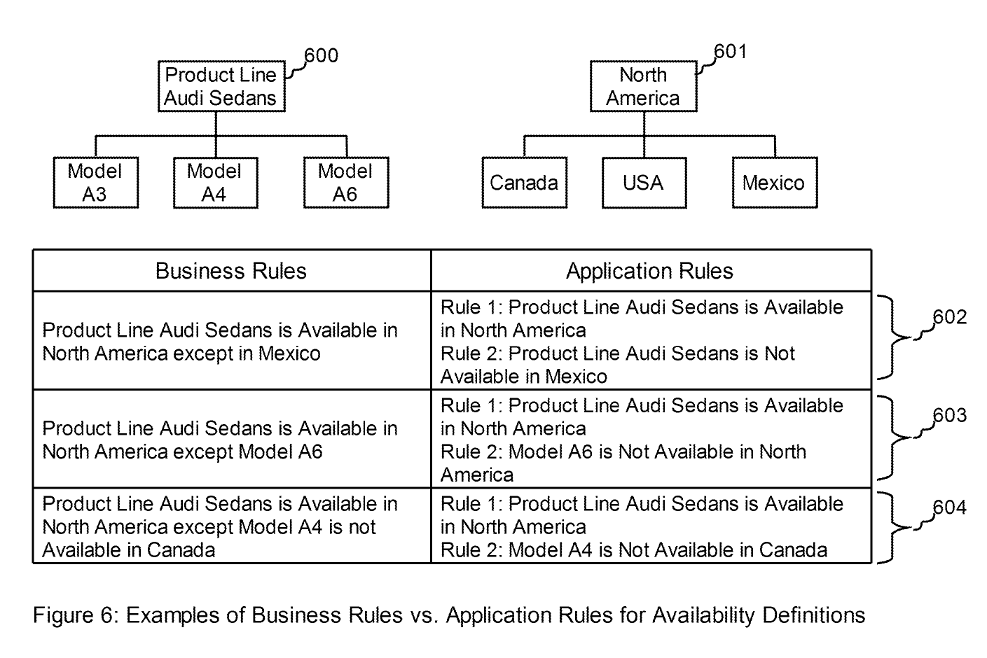

FIG. 6 depicts example benefits of how the example System reduces the gap between business rules and application level rules in Availability definitions. The hierarchy 600 is a simplified Product Hierarchy, and hierarchy 601 describes a simplified Selling Domain hierarchy. Both these hierarchies are used in the different examples of business rules and the corresponding application rules depicted in 602, 603, and 604. The presence of an underlying Availability Rules engine along with the hierarchy definition enables us to close the gap between business rules and application rules.

Examples of Availability rules defined as Business rules in 602, 603, 604, are each represented by exactly two application rules. In the absence of the hierarchies defined in 600 and 601 and the underlying rules engine to enforce these hierarchies, one would need nine application rules required to express each example of business rules in 602, 603, and 604. This number of application rules is arrived at from multiplying the number of products with the number of countries in the example depicted in FIG. 6. In fact, in most real applications, the number of products and number of values in the selling domain are much larger, resulting in a proliferation of application rules for each business rule for Availability. The benefit from the example System is to reduce the number of application rules required to express Availability-related business rules, resulting in benefits such as better performance and scalability, maintainability, and reduced time to market for new products and services.

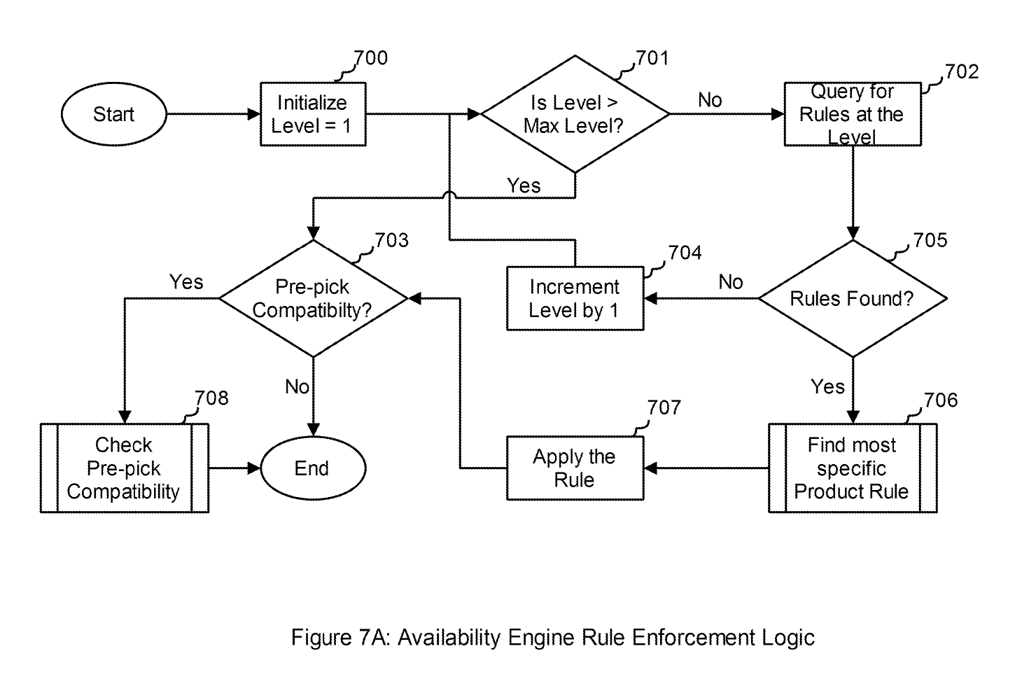

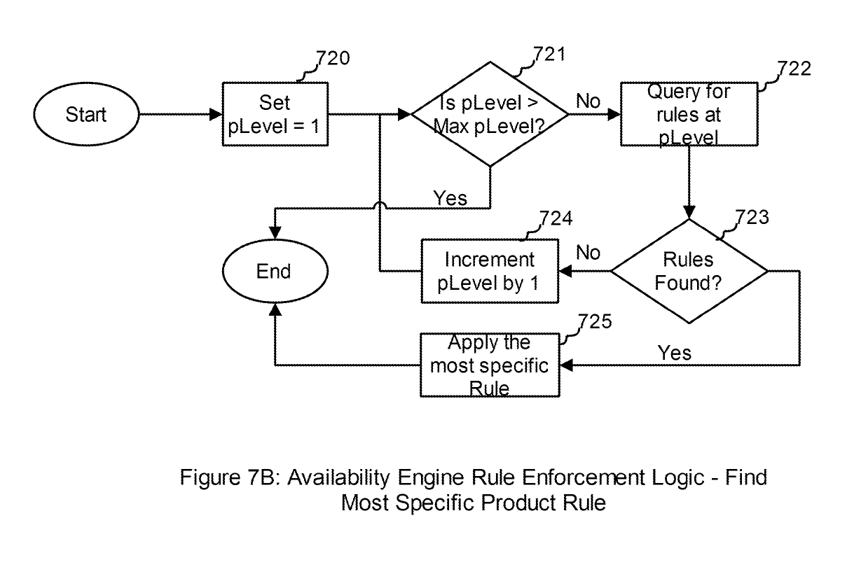

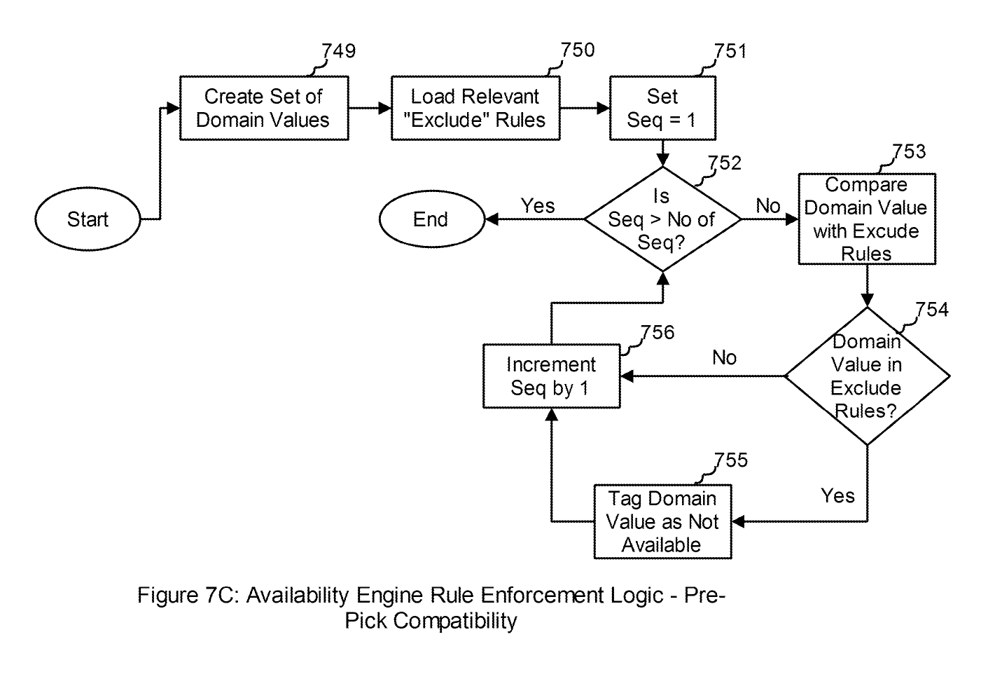

FIGS. 7A, 7B, and 7C describe the methodology to enforce the Availability rules. FIG. 7A presents the schematic of the Availability Engine rule enforcement logic. The inputs into the rules enforcement logic includes line item (or items), its (or their) “context”, Compatibility pre-pick Flag, user/customer and their related attributes such as type, location, industry segment, etc., selling domain value and its attributes such as the channel, customer location or the location where the products and services will be delivered and/or consumed, and any number of product attributes such as product category, product family, parent product, etc. Input line items could comprise line items in a quote or an order or an agreement. Input line items could also be the set of products/options in a product configuration, or a set of products in a catalog or a set of products in a product pick list, or a set of products comprising an asset (or install base) a customer currently owns. The “context” refers to a set of attribute values that are common across all the line items. Examples of “context” include user/customer and their related attributes, selling domain, channel, Compatibility pre-pick flag, etc. The outputs of the Availability rules enforcement includes a status at the line item level indicating if the item is available/or not available and reason why it is not available.

For the example embodiment, all the steps depicted in FIG. 7A apply to each line item for which Availability Rules need to be enforced. Step 700 first initializes the value of Level to 1. The level here refers to the level in a generic hierarchy as described in FIG. 3, or examples such as those represented in FIGS. 4A, 4B, and 6. Max Level refers to the maximum number of levels used in the hierarchy that needs to be traversed. Step 701 checks if the value in the Level variable is greater than the maximum number of levels, Max Level. If the value of Level is greater than Max Level, then check for Pre-pick Compatibility, 703. Otherwise, if the value of Level is less than or equal to Max Level, execute query for all rules applicable at that level of the hierarchy, 702.

The output from Step 702 is a set of Availability rules defined at the Level of the hierarchy (selling domain hierarchy for example) that may apply to the line item. Step 705 checks if there are any Availability rules defined at the Level of hierarchy. If no rules exist, then the System looks for Availability rules at the next level in the hierarchy by incrementing the value of Level by 1 in Step 704. If Availability rules are defined at the Level, then the most specific Availability rule needs to be applied by finding the most specific Product rule in Step 706. Step 707 applies the most specific product rule from among the Availability rules defined at a Level. As a result of this rule being enforced, the line item status may be set to “Available” or “Not Available”. In addition, there may be some description of which Availability rule was applied for that line item. Step 703 checks if value of the Pre-pick Compatibility flag is true. If the Pre-pick Compatibility flag is true, then the System enforces Pre-pick Compatibility rules in Step 708.

There may be variations to the Availability Rules enforcement logic presented here as alternative embodiments. For example, one could interchange the order in which the rules at different levels of the generic or selling domain hierarchy (Step 702) and find the most specific product rule, Step 706, are executed. This change in order will still produce the same end-result in terms of the Availability status of the line item.

Pre-pick Compatibility flag is true when product and its options are being configured during the quoting process. Typically product configurations group options into “relationships”. For example, in a product configuration representing a computer system, the set of disk drive options could be grouped into a “storage options relationship” while the set of options for processor could be grouped into a “processor option relationship”, etc. As the user makes selections among options within a “relationship”, product configuration rules could exclude options in some other relationships. Pre-pick Compatibility capability uses the existing option selections within the product configuration and the associated configuration rules to determine which options comprising the domains of other relationships are excluded (or “Not Available”). In the case of Pre-pick Compatibility rules enforcement, the set of line items for which Availability rules are being enforced comprises the domain of option selections within each relationship of the product configuration.

FIG. 7C depicts the logic used in the example embodiment to determine Pre-pick Compatibility. Step 749 represents the creation of a set of domain values, or the line items. The Availability Status of each line item is the output from this Pre-pick Compatibility sub-process. In addition to the inputs required for the parent process described in FIG. 7A, this sub-process also utilizes the current product configuration instance as an input. Step 750 loads all the Compatibility rules of type “Exclude” referring to current product configuration. These compatibility rules could be defined at any level of the product hierarchy. No of Seq is the number of line items that are to be processed while Seq is the counter that tracks the item being processed. Step 751 initializes the value of Seq to 1. Step 752 checks if the value of Seq exceeds No of Seq. If the value of Seq exceeds No of Seq, then all the line items have been processed, otherwise, go to Step 753. Step 753 compares line items' product and attribute values against the set of “Exclude” rules loaded in Step 750. If the line item product and/or product attribute values are found in the set of “Exclude” rules (Step 754), then the line item's Availability Status is set to “Not Available” in Step 755. Otherwise, the System increments the value of Seq by 1 in Step 756 in order to process the next line item.

FIG. 7B depicts the logic used in the example embodiment to find the most specific product rule. This logic is one of the sub-processes (Step 706) in FIG. 7A. Inputs into this sub-process are the line item and the set of Availability Rules defined at the specific level of the generic hierarchy. This sub-process traverses the product hierarchy to identify the most specific Availability rule from among the input set of rules. Step 720 initializes pLevel to 1. The pLevel refers to the level in the product hierarchy. Step 721 compares if the value of pLevel is greater than Max pLevel. If pLevel is less than or equal to the Max pLevel, then query for rules among the relevant Availability rules in Step 722. Step 723 checks if there are Availability rules defined at a level corresponding to pLevel of the product hierarchy. If there is a rule, then this most specific rule is applied to the line item. As a result, the line item availability status could be set to “Available” or “Not Available” depending upon the rule definition in Step 725. If no Availability rules are found in Step 723, then the System increments the value of pLevel by 1 and go to Step 721.

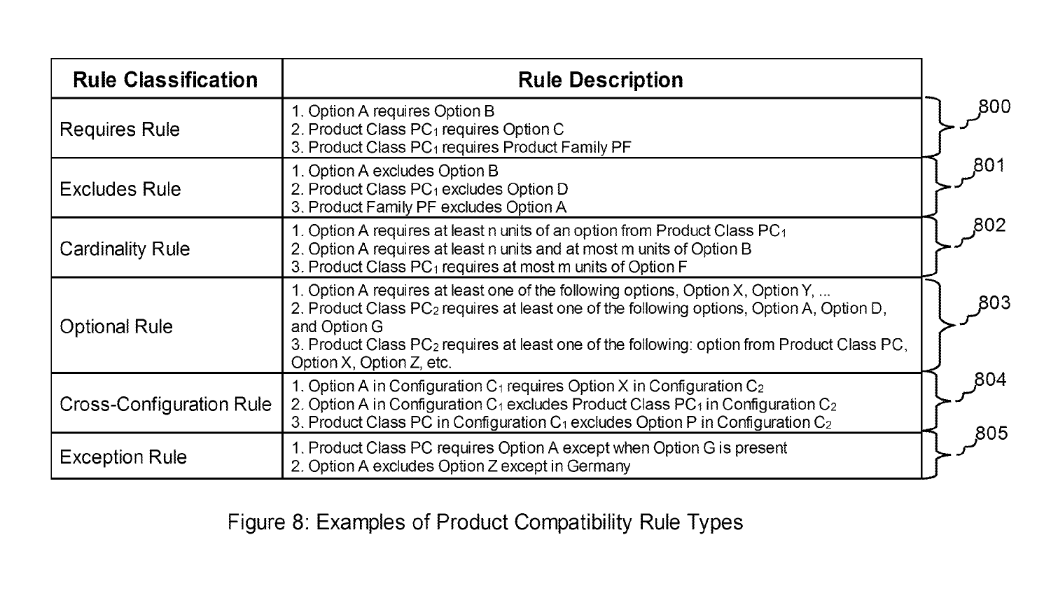

FIG. 8 describes different types of Compatibility Rules used in the example embodiment. Compatibility Rules can be defined at any level of the product hierarchy. FIG. 8 also presents examples of each type of Compatibility Rules. Row 800 represents the Requires rules, one of the basic and commonly used Compatibility Rule type. This type of rule can be used to define the options or groups of options that are to be sold together. Row 801 represents the Excludes rules, another basic and commonly used Compatibility Rule type. Exclude rules are used to define options that cannot be sold together. Both of these rule types can be defined at different levels of the product hierarchy, i.e., at Product Family level, Product Category level, product configuration level, or at the option level. These rules can also be defined at the level of an arbitrary grouping of options. Row 802 represents the Cardinality rules. Cardinality rules are always defined on top of “Requires” rules. A Cardinality rules could be used to define the minimum number of units, maximum number of units, or both, of an option that need to purchased within the product configuration. Row 803 describes examples of the Optional Rules. These rules are also defined on top of “Requires” rules. Row 804 depicts examples of Cross-configuration Rules. These rules typically span multiple configurations and can be defined on top of Requires as well as Excludes Rules. Cross-configuration Rules enable product configurations to be more modular, resulting in a better performance and scalability. Row 805 depicts Compatibility Rules of type Exception. Exception Rules are conditions when the parent rule is enforced or not enforced. There could be any number of different types of Exception conditions, such as product-based exceptions and rule Eligibility-based exceptions. Product-based exception conditions define when the presence of an option requires the parent rule is not to be enforced. Eligibility-based exception conditions are cases when a rule is not to be enforced or needs to be enforced. Example #1 in Row 805 is an example of a product-based exception, while #2 is an example of an Eligibility-based exception. Eligibility-based exception can be defined on the value of sales domain, channel, customer, or customer characteristics, or combinations thereof, etc.

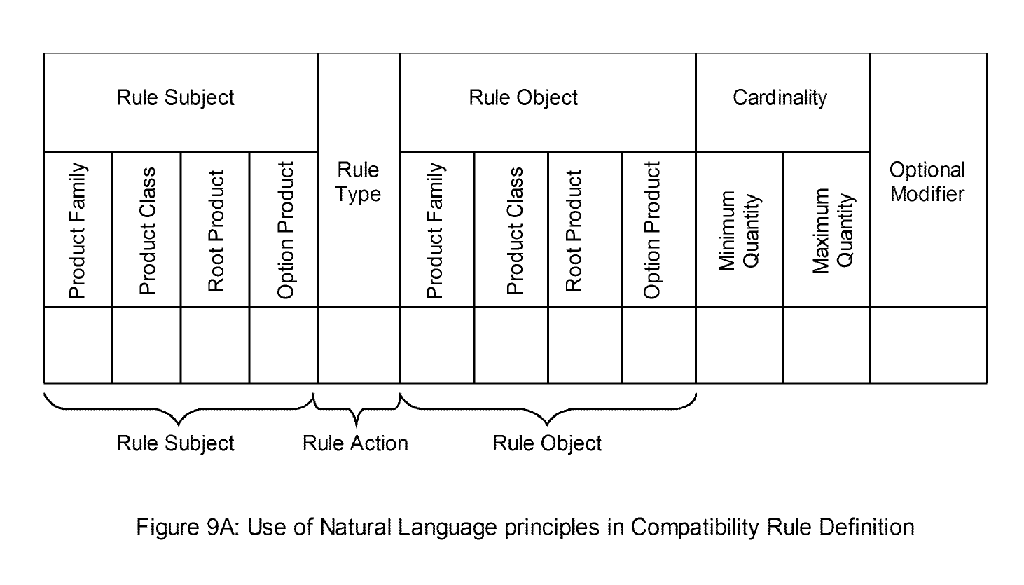

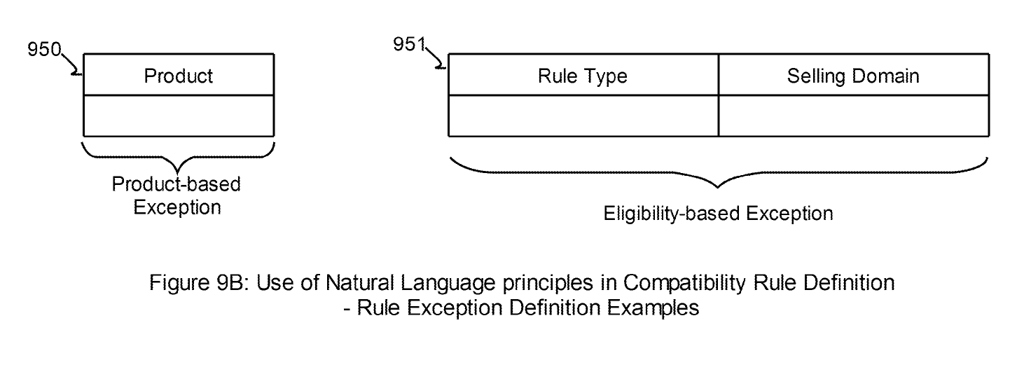

FIGS. 9A and 9B depict a schematic of the user interface used to define Compatibility rules and their exceptions for the example embodiment. FIG. 9A depicts rule definition and how this definition leverages natural language principles. Analogous to the syntax of a sentence which comprises a subject, an object, and a verb, the Compatibility rule definition also comprises a subject, an object, and an action (rule action). The rule action can have values such as Requires, Excludes, and Recommends. In addition, the rule definition also includes a Cardinality specification and an Optional Modifier. Cardinality specification is used to define the minimum and/or the maximum number of units of object options required with each unit of the subject option. Optional modifier is used to indicate that this rule has multiple objects out of which at least one must be selected in a product configuration. The Compatibility rule subject and object can be defined at any level of the product hierarchy.

FIG. 9B depicts examples of a user interface schematics for definition of Compatibility Rules as used in the example embodiment. Product-based exceptions that enable the user to define rules that would not be applicable in presence of the “exception” products in the configuration. The example of the Eligibility-based exceptions depicted in the schematic uses Selling domain as a criterion. One could expand the set of exception criteria to include attributes such as channel, account, customer, customer types, etc.

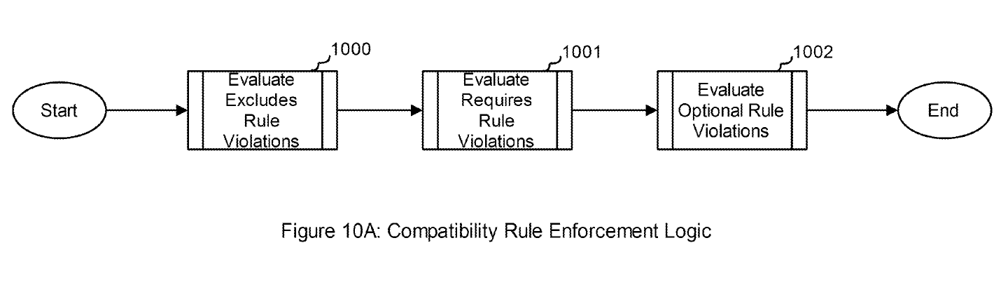

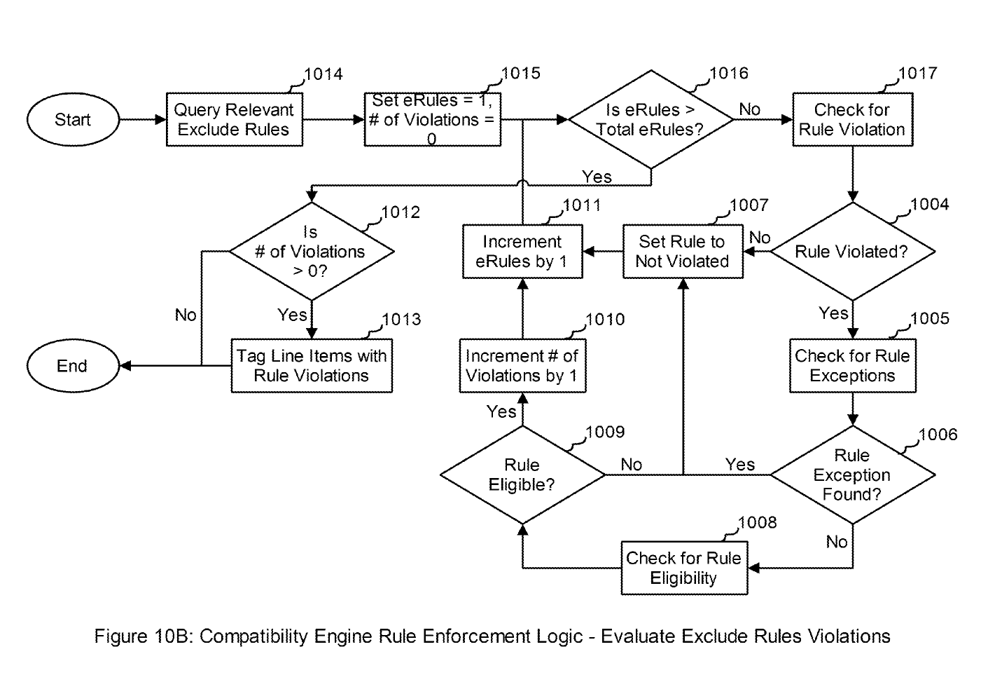

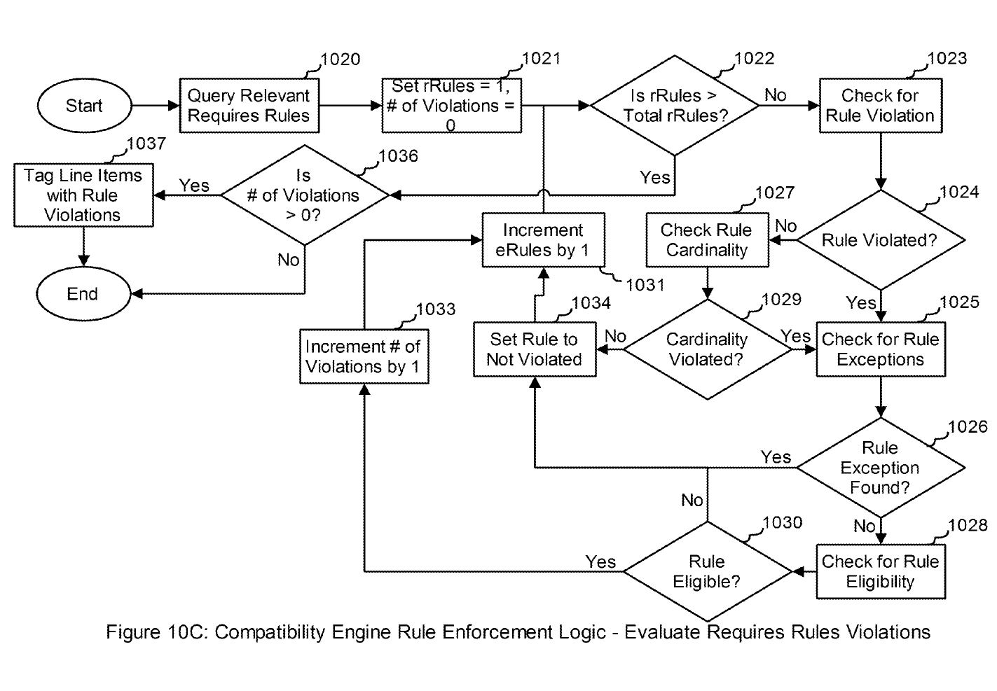

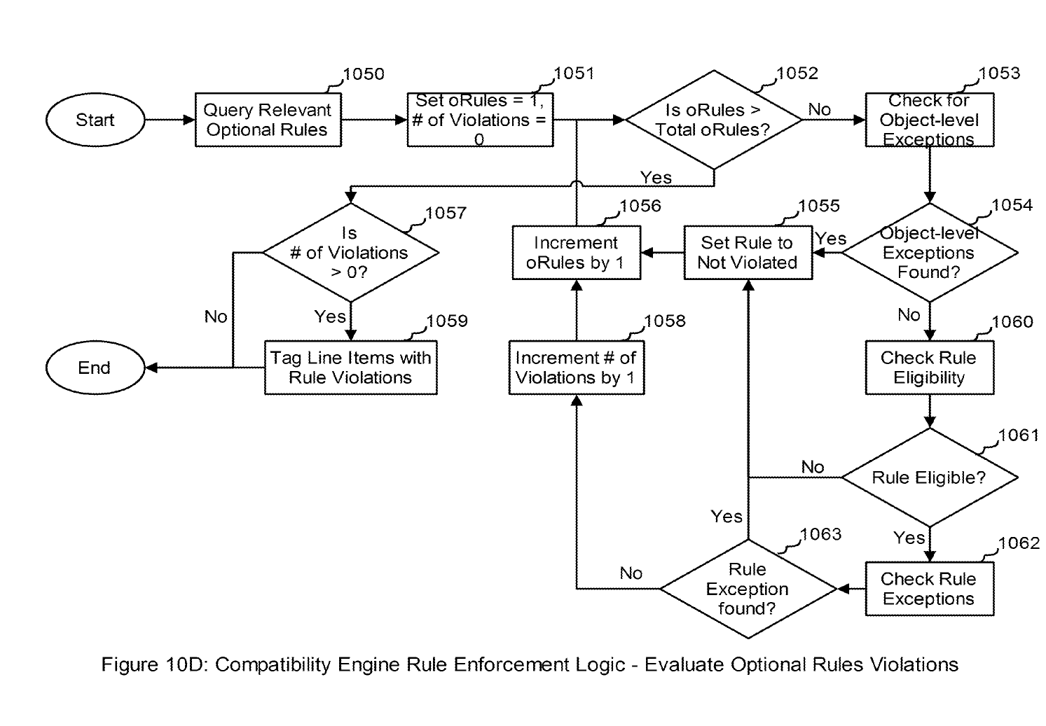

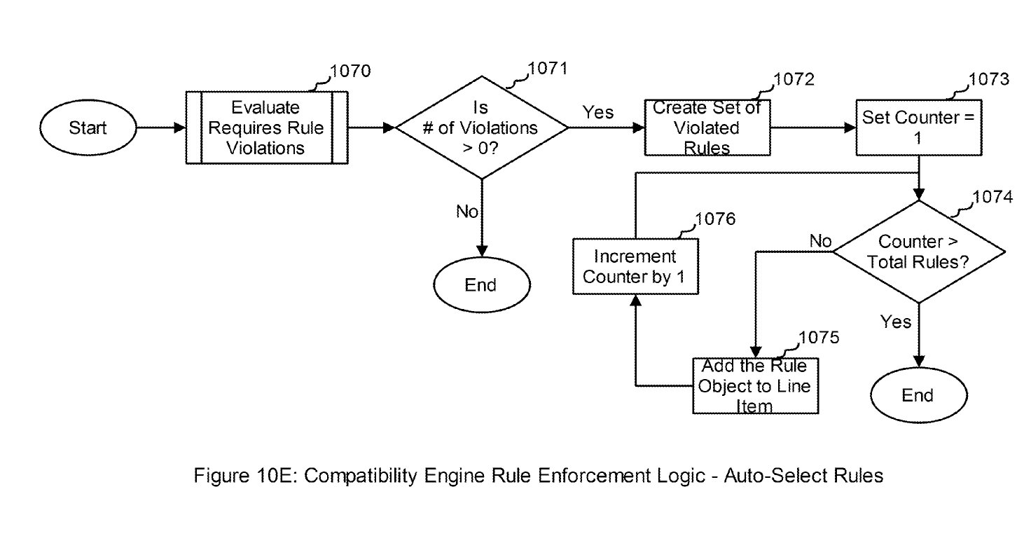

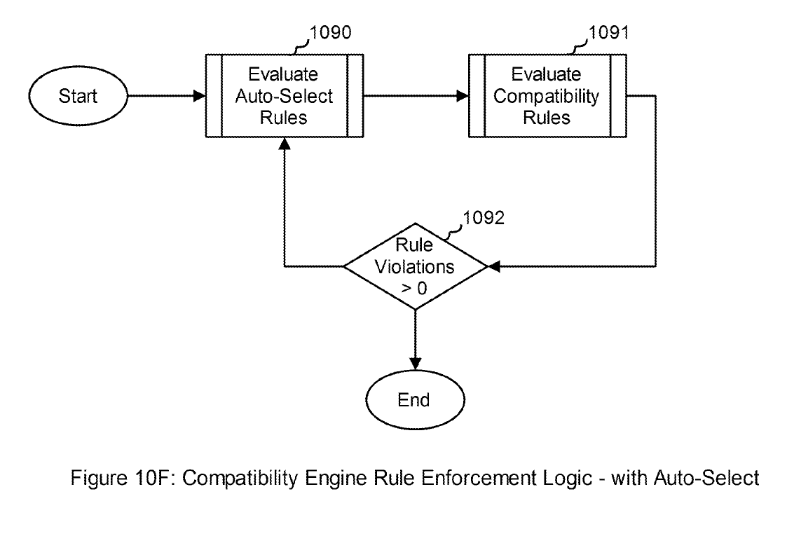

FIGS. 10A, 10B, 10C, 10D, 10E, and 1OF describe the logic in the Compatibility Rule enforcement as used in the example embodiment. FIG. 10A presents an overview of the Compatibility Rule enforcement logic. The input into this process is a line item or a set of line items (as in the Availability rule enforcement described earlier), and the context for these line items which contains information that is common across all the line items. The context may contain attributes such as customer and their attributes, selling domain information, channel, etc. Outputs from this process include the Compatibility status for each line item and if the line item violates some rules, a description of the rules that are violated.

The first step in the compatibility enforcement logic described in FIG. 10A is to evaluate if rules of type “Excludes” are being violated, 1000; following this, evaluate if rules of type “Requires” are being violated, 1001, and finally check if any Optional rules are being violated, 1002, by any lines comprising the set of line items. Subsequent figures detail how each of these types of rule violations are being evaluated.

FIG. 10B describes how Exclude Rules violations (as depicted in Step 1000 in FIG. 10A) are evaluated. Inputs and outputs for this process are the same as those for the parent process described in FIG. 10A. The first step in the evaluating Exclude Rules violations, 1014, is to identify the subset of relevant Exclude rules. Step 1014 queries the Product Configuration Rules Module, 208, depicted in FIG. 2. The relevant set of Exclude rules is defined as the rules defined at any level of the product hierarchy for products appearing in the input set of line items, and Rule Type is “Excludes”. The query into the Product Configuration Rules Module, 208 (from FIG. 2) is based on the above-mentioned criterion. The output from this step is a set of relevant Exclude Rules, and a count of the number of rules in this set, Total eRules. Once the set of relevant Exclude Rules has been created, the System iterates through each rule to determine if it is being violated. Step 1015 initializes the values of some counters such as eRules, which is used to determine which rule among the set of relevant rules is being processed, and the # of Violations, which counts the number of rules in the Exclude Rules' set have been violated. By default the System initializes the status of all rules in the Exclude Rules' in the set to be “Violated”.

Step 1016 is the beginning of the iteration loop to determine which of the Exclude Rules in the set are being violated. Step 1017 does the first check of rule violation by checking if the Exclude rule's subject and object product options are present in the line item set. For example, if the Exclude Rule says “Option A excludes Option B”, then Option B should not be in the line item set. If one of the line items contains the product Option B, then this rule is violated. Step 1004 checks if the current Exclude rule is violated, if it is violated, then it checks if there are exceptions that would make this rule not applicable, and hence, not violated. If the rule is not violated, then set the status of this rule to “Not Violated” in Step 1007. Step 1005 checks for rule exceptions such as presence of another product, or channel, or account type, etc. If this type of exception exists (checked in Step 1006), then set the status of this rule to “Not Violated” in Step 1007. Otherwise, check if there are eligibility conditions, Step 1008, that would result in rule not being applicable. These eligibility conditions could be defined based on selling domain, and/or other criteria such as customer and its attributes, channels, industry segments, etc. If there is a eligibility condition that makes the rule not applicable, Step 1009, then the status of the rule is set to “Not Violated” in Step 1007. Otherwise, increment the counter for the number of violations, # of Violations, by 1, and the counter for Exclude Rule being processed, eRules, by 1, in steps 1010 and 1011 respectively. This is the end of an iteration loop. The process starts again in Step 1016 to determine if there are any remaining rules in the set of relevant Exclude Rules to be processed. If there are no rules to be processed, then the System needs to check if any rule violations were found in Step 1012. If there are no rule violations, the process ends, otherwise, the System tags the relevant line items with the rules violated in Step 1013. This step sets the status of the line item as Rule Violation, and in a description field enters a descriptive message on the rule(s) being violated.

Requires Rules violation evaluation is a sub-process, 1001, in the Compatibility Engine Rules Enforcement process depicted in FIG. 10A. FIG. 10C depicts the evaluation of violations of Compatibility rules of type Requires Rules. This evaluation includes enforcement of all types of Compatibility rules where the Rule Type is “Requires” and Optional Modifier is false. Inputs and outputs into this sub-process are identical to those for the parent process described in FIG. 10A. Step 1020 queries and loads the set of relevant Requires Rules from the Product Configuration Rules Module, 208, described in FIG. 2. The relevant set of Requires Rules is defined as rules defined at any level of product hierarchy for products appearing in the input set of line items, Rule Type is “Requires”, and having the Optional Modifier value set to false. The status of all relevant Requires Rules in this set is initialized to “Violated”, and the value of Total rRules is set to the number of rules in the relevant Requires Rules set. Step 1021 initializes counters such as rRules to 1, # of Violations to 0.

Step 1022 is the start of the iterative process of determining if the rules in the relevant Requires Rules set are being violated or not. The process starts by checking if rRules is greater than the Total rRules. This condition not being satisfied implies that there exist rules in the relevant Requires Rules set that need to be evaluated for violation. Step 1023 performs the product-level test to check for rule violation. This step checks if the line items contain a product that could satisfy the object definition in the Requires rule. Step 1024 checks if there is a line item among the set of line items that can satisfy the object definition of the rule. If rule is violated, then the System checks for exception conditions that could make the rule not applicable, and hence not violated. The first exception that is checked is in Step 1025. This step checks for the presence of an exception such as another product (among the set of line items) or channel, or customer or their attributes. The existence of such an exception is tested in Step 1026. If an exception is found, the status of the rule is set to “Not Violated” in 1034, otherwise the System checks if the rule is eligible in Step 1028. This eligibility check is for exceptions defined based on attributes such as selling domain, channel, or even customer attributes. Step 1030 checks if the rule is eligible, if it is then number of violations are incremented by 1 in Step 1033, otherwise the status of the rule is set to “Not Violated” in Step 1034. For rules that are not violated from a product perspective in Step 1024, they may violate the cardinality requirements. Therefore, Step 1027 checks if the option has the requisite number of units, i.e., the number of units for the option (in the rule object) is between the minimum and maximum number specified in the rule. If the cardinality constraint is satisfied in Step 1029, then the rule status is set to “Not Violated” in Step 1034, otherwise the System checks if there are exception conditions that would make the rule not applicable, i.e., not violated. These checks start with Step 1025.

After the rule status has been updated, if necessary, in Step 1034, or the number of violations has been incremented in Step 1033, the counter, eRules, is incremented by 1. This enables us to process the next rule (if one exists) in the relevant Requires Rules set. Once all the rules in the relevant Requires Rules set have been processed for violations, i.e., condition in Step 1022 is true, the System to checks if there are any violations in Step 1036. If the number of violations among the relevant Requires Rules set is greater than 0, then the System tags the line items in the set of line items with the rules' violations in Step 1037. In Step 1037 the status of appropriate line items is updated to “Rule Violated” and a description field with a description of the rules being away.

FIG. 10D describes the process for evaluating Optional Rules violations. The inputs and outputs for this sub-process are identical to the inputs and outputs for the parent process described in FIG. 10A. Inputs include the set of line items and their context. The first step, Step 1050, in the process is to create the set of relevant Optional Rules. The set of relevant Optional rules is queried from the Product Configuration Rules Module, 208, described in FIG. 2. The set of relevant Optional Rules is defined as the rules defined at any level of product hierarchy for products appearing in the set of line items and for which the Optional Modifier is true. The output from this step includes setting the value of the total number of optional rules, Total oRules. Step 1051 initializes the values of counters such as oRules to 1, and # of Violations to 0. Step 1052 is the beginning of the iterative process of evaluating if a rule within the set of relevant Optional Rules is being violated. If the value of oRules is not greater than Total oRules, then the System checks for optional exceptions in Step 1053. Evaluating optional exceptions is different from the exception evaluations in the case of Requires Rules and Excludes Rules. Unlike Requires Rules and Exclude Rules, an Optional Rule usually has more than one object. As a result, Optional Rules “exceptions” evaluation comprising evaluating the options appearing in the rule object. This step checks if any of the optional rule exceptions defined at any level of the product hierarchy appears among the set of line items. If Optional Rules exceptions are found (in Step 1054), the status of the Optional Rule is set to “Not Violated” in Step 1055, otherwise the System checks for rule eligibility-based exceptions in Step 1060. If Eligibility based exception exists, Step 1061, then rule status is set to “Not Violated” in Step 1055, otherwise, need to check for product-based exception in Step 1062. If there are product-based exceptions, set the rule status to “Not Violated” in Step 1055. Otherwise, increment the number of violations by 1 in Step 1058. The rule has now been evaluated for violations and the System is ready to process the next rule in the set of relevant Optional Rules, so increment the counter oRules by 1 in Step 1056 and go to the start of the iteration in Step 1052. Once all rules have been processed, the System checks if there are violations of optional rules in Step 1057. If there are violations of optional rules, the System tags the relevant line items with violations in Step 1059. If there are no violations or once line items have been tagged with violations, the process ends.

FIGS. 10E and 1OF describe the Auto-Select Rules enforcement process. Auto-Select Rules is a capability to improve usability of the application while selecting options during the product configuration process. For example, if a user selects an option and that option requires selection of several additional options, Auto-Select Rules capability would add the additional required options to the product configuration automatically, reducing the number of clicks the user has to perform. FIG. 10E describes the process of how Auto-Select Rules are enforced. Inputs into this process are the set of line items, their context, and the outputs from this process are an updated set of line items and their status. Step 1070 executes the Requires Rules violations for the set of line items. This process is depicted in more detail in FIG. 100. The output from this step is the number of violations, # of Violations. Step 1071 checks if there are any violations of Compatibility Rules of type Requires. If there are no violations, then the process ends. However, if the number of violations is greater than zero, create the set of violated rules in Step 1072. This step queries the Product Configuration Rules Module, 208, depicted in FIG. 2, for relevant Compatibility Rules of type Requires. The set of relevant Compatibility Rules of type Requires is defined as rules of type Requires (that are not Optional Rules) with object defined at the level of an option for line items which contain violations. The output from this step is a set of rules of type Requires that are violated, and a count of such rules, Total Rules. Step 1073 initializes the value of Counter to 1. This counter is used to iterate through the violated rules whereby their violations are addressed in the set of line items. Step 1074 checks if there are any rules with violations that need to be processed. If there are no such rules, the process ends. Otherwise, in Step 1075 add the option appearing the rule object to the set of line items. While adding this object, the System checks to ensure that cardinality requirements are satisfied by adjusting the value of the unit quantity. Step 1076 increments the counter by one so that the next rule in the set of violated rules can be processed.

FIG. 1OF depicts how the Auto-Select rule enforcement process is invoked. The input into this process is the set of line items, their context, while the output from this process is an updated set of line items, their context, and the set of unresolved violations. Step 1090 is the first pass through evaluating Requires rules violations among the set of line items. This sub-process is described in more detail in FIG. 10E. Step 1090 is followed by enforcement of all types of Compatibility Rules in Step 1091. This sub-process is described in more detail in FIG. 10A. The output from Step 1091 is the updated status of each line item with rule violations, if any. Step 1092 checks if there are any line items with violations of Compatibility Rules of type Requires. If there are, then it triggers the Auto-Select Rules evaluation, Step 1090, again until all such violations are resolved.

The System can provide the user with one or more reports that present the user with the marketing solutions that the System determines using the above procedures and logic. These reports might be in the form of web pages that are served by the System's web server, or might include a more extensive document. Ultimately, the System will report the results in a manner that is easily understood by the user, so that the user can determine which product configurations are permitted and which are not, which product applications are permissible and which are not, and whether the product is available (in a given configuration and/or for a desired application) for the particular sales structure (e.g., a desired geographical location, sales channel, etc.).

Example Use of the Example System

We now provide an example for using the System embodied in a software application running on a computer and networking hardware depicted in FIGS. 1, 1A, and 1B. Let us take the example of a hypothetical customer, John D, of a telecommunications service provider, Telco. John D currently subscribes to a home phone service, internet service, wireless service, and cable TV service from Telco for his home in San Francisco. John D is moving to Middletown, Ohio, and would like to migrate his home telephone service, wireless phone subscription, internet service, and cable TV service to his new address in Middletown, Ohio. John calls the service representative for Telco. The service representative who works in a call center and uses multiple software applications including the CRM Application Suite answers the phone to address John D's service request.

After getting basic information to identify John D, the service representative creates a service request in the Service Management System 6 of the CRM Application Suite. Through integration with the External Applications 7 that includes an application that stores Install Base information, the service representative is able to bring up information about John D's existing subscriptions. In order to execute the move, the service representative gets John D's new address in Middletown, Ohio, and the effective date for the transfer and enters that information into the service request. The service representative then checks if it is indeed possible to offer all of John D's existing services in Middletown, Ohio. The service representative launches the product configuration session/service in Quote and Order Management System 5 to transfer the existing home phone service to the new address in Middletown, Ohio. The product configuration session enforces rules defined in the Product Configuration Engine Rules Module 202 described in FIG. 2. She finds that all the features of the existing home phone service plan are available in Ohio as well, except that the no-directory listing option costs an additional $1.99 per month. John D decides to drop this feature from the home phone service to be applied to his new address, so the service representative modifies the service plan options.

The service representative now launches another product configuration session to transfer the wireless service to John D's new address. The configuration session which enforces rules defined in the Product Configuration Engine Rules Module 202, reveals that all of the features of the wireless plan are available in Middletown, Ohio. The product configuration session also recommends that John D could upgrade to a smart phone handset with blue-tooth device for free if he were to make a two-year commitment. John D accepts the upgrade offer and the service representative updates the configuration of John D's wireless plan. The service representative now wants to check on moving the internet access service to the Middletown, Ohio, address. Again, she finds John D's existing internet access subscription in the Install Base application (among the External Applications 7) and launches the product configuration session to ensure the plan is valid based on rules defined in the Product Configuration Engine Rules Module 202. Based on the details of the new address, the product configuration session indicates that Telco does not offer internet access service at the Middletown, Ohio, address. As a result, John D decides cancel his internet service before moving from his current location.

Finally, the service representative prepares to move the cable TV service. She searches for John D′s existing cable TV subscription in the Install Base application (among the External Applications 7) and launches the product configuration session to enforce configuration rules defined in the Product Configuration Engine Rules Module 202 for cable TV plans in Middletown, Ohio. Upon entering the details of the new address in Middletown, Ohio, she discovers that some of the foreign language channels in the existing subscription are available only if John D were to buy a premium channel package in Middletown, Ohio. John D decides to buy the premium channel package in his new cable TV subscription, the service representative makes the changes to the configuration of John D's new cable TV subscription, and then summarizes all the changes that have been implemented, and additional charges to be paid before closing the call.

The invention has been described herein using specific examples and embodiments; however, it will be understood by those skilled in the art that various alternatives may be used and equivalents may be substituted for elements and/or steps described herein, without deviating from the scope of the invention. Modifications may be necessary to adapt the invention to a particular situation or to particular needs without departing from the scope of the invention. It is intended that the invention not be limited to the particular implementations and embodiments described herein, but that the claims be given their broadest interpretation to cover all embodiments, literal or equivalent, disclosed or not, covered thereby.

1. A method of using a computer system for determining a product model permitted by a vendor, said method comprising the steps of:
receiving information into the computer system from a remote terminal connected to the computer system via a communication network, said information including:
Information about at least one requested product configuration and/or at least one requested product application, and
Information for determining an availability of the product in its requested configuration(s) and/or for the requested application(s) for a requested sales structure;
storing a plurality of business rules in said computer system, wherein
at least one of said business rules is comprised of a general rule and at least one exception, and wherein
at least two of said business rules are hierarchically arranged with respect to each other such that one of said hierarchically arranged rules takes precedence over the other(s) of said hierarchically arranged rules;
applying, using said computer system, said plurality of business rules to the information to generate at least one product report as a result of said applying said plurality of business rules, such that said product report provides information indicating an assessment of:
(1) whether said requested product configuration is or is not a permitted product configuration and/or whether said product is or is not permitted for the requested product application, and
(2) whether the desired sales structure is or is not a permitted sales structure; and
providing, using said computer system, said product report to said remote terminal via said computer network.

2. The method of claim 1, wherein said information includes Information about the at least one requested product application requested product application which includes whether the requested product can be sold with another particular product and/or can be used for a particular installation.

3. The method of claim 1, wherein said information includes Information about the at least one requested product configuration which includes one or more optional accessories that may be installed or, or included with, the product.

4. The method of claim 1, wherein said requested sales structure includes whether the product in the requested configuration and/or for the requested application can be sold in a particular geographical location.

5. The method of claim 1, wherein said requested sales structure includes whether the product in the requested configuration and/or for the requested application can be sold to a particular type of account.

6. The method of claim 1, wherein said requested sales structure includes whether the product in the requested configuration and/or for the requested application can be sold to a particular account.

7. The method of claim 1, wherein said requested sales structure includes whether the product in the requested configuration and/or for the requested application can be sold through a particular channel.

8. The method of claim 1, wherein said business rules include a plurality of compatibility rules each for determining the compatibility of a corresponding product configuration and/or application, wherein said plurality of compatibility rules are arranged hierarchically to determine the precedence of said compatibility rules with respect to each other.

9. The method of claim 8, wherein at least one of said compatibility rules includes a general compatibility rule and at least one compatibility exception.

10. The method of claim 1, where said business rules include a plurality of availability rules for determining the availability the requested sales structure, wherein said availability rules are arranged hierarchically to determine the precedence of said availability rules with respect to each other.

11. The method of claim 10, wherein at least one of said availability rules includes a general availability rule and at least one availability exception.

12. The method of claim 11, wherein said compatibility rules include a subset of rules having exclusions, a subset of rules having requirements, and a subset of rules having options, wherein the rules are processed in the order of processing the exclusions prior to processing the requirements prior to processing the rules having options.

13. The method of claim 1, wherein at least some of said rules are formatted having a subject, an object, and a verb representing an action between the subject and the object.

14. The method of claim 1, wherein at least a subset said plurality of business rules are arranged in N hierarchical levels with N greater than or equal to three, each of which may have more than one of said business rules, such that all business rules at the 1^{st} level take precedence by overriding all rules at any other levels, and such that for n=2 to N−1, rules at the n^{th} level take precedence by overriding all rules at the (n+1)^{st} level and above, and such that all business rules at the N^{th} level do not take precedence over any of the rules at any other level.

15. The method of claim 14, wherein NP3, and wherein the 1st level represents a city or postal code, where the 2^{nd} level represents a state or province, and wherein the 3^{rd} level represents a country.

16. The method of claim 15, wherein NP4 and wherein the 4^{th} level represents a continent.

17. A method of using a computer system for determining a product model permitted by a vendor, said method comprising the steps of:
Inputting a plurality of business rules for storing in said system, wherein said business rules include the syntax of:
a subject,
an object, and
a verb, wherein
said business rules include a subset of compatibility rules such that, for each one of said compatibility rules, the respective subject represents a particular aspect of the product, the respective object represents some other aspect of the product, its options, another product, or a product application, and the respective verb represents some action between them, and wherein
said business rules also include a subset of availability rules such that, for each one of said availability rules, the respective subject represents the product, the respective object represents a selling domain, and the respective verb represents some action between them, and wherein
at least some of said business rules are hierarchically arranged with respect to each other such that the hierarchically arranged rules takes precedence over each other based on their position in the hierarchy;
receiving information into the computer system from a remote terminal connected to the computer system via a communication network, said information including:
Information about at least one requested product configuration and/or at least one requested product application, and
Information for determining an availability of the product in its requested configuration(s) and/or for the requested application(s) for a requested sales structure;
applying, using said computer system, said compatibility rules to said information to determine whether said requested product configuration is or is not a permitted product configuration and/or whether said product is or is not permitted for the requested product application;
applying, using said computer system, said availability rules to said information to determine whether the desired sales structure is or is not a permitted sales structure; and
providing, using said computer system, a product report to said remote terminal via said computer network to report results from said applying steps.

18. The method of claim 17, wherein at least one of said business rules is comprised of a general rule and at least one exception.

19. The method of claim 17, wherein said selling domain includes geographical information.

20. The method of claim 19, wherein the action between the subject of at least one of the availability rules and the respective object of that availability rule includes whether the configured product is available or not available in a given geographic location represented by the object.

21. The method of claim 17, wherein the action between the subject of at least one of the compatibility rules and the respective object of that compatibility rule includes whether the configuring the product with the option represented by the object is permissible, excluded, or required.

22. The method of claim 17, wherein the subject of at least one of the compatibility rules represents a class of products and the respective object of that compatibility rule represents a subclass or component of the object, and wherein the action represents whether the subclass or component is permitted in combination with the class.

23. A system for determining a product model permitted by a vendor, comprising:
a web server for serving data to, and receiving information from, a user computer, wherein said received information includes:
information about at least one requested product configuration and/or at least one requested product application, and
Information for determining an availability of the product in its requested configuration(s) and/or for the requested application(s) for a requested sales structure;
an application server for executing included software for implementing business logic for producing data that is formatted into a report by the web server for transmission to the remote computer, wherein
said business logic includes a plurality of business rules such that:
at least one of said business rules is comprised of a general rule and at least one exception, and wherein
at least two of said business rules are hierarchically arranged with respect to each other such that one of said hierarchically arranged rules takes precedence over the other(s) of said hierarchically arranged rules, and wherein
said business logic applies said plurality of business rules to the received information to generate at least one product report as a result of said applying said plurality of business rules, such that said product report provides information indicating an assessment of:
(1) whether said requested product configuration is or is not a permitted product configuration and/or whether said product is or is not permitted for the requested product application, and
(2) whether the desired sales structure is or is not a permitted sales structure; and
providing, using said web server, said product report to said user computer.
